(19) United States
(12) Patent Application Publication
(10) Pub. No.: US 2026/0329547 A1
(43) Pub. Date: Oct. 22, 2026

(54) EXECUTING REUSABLE FUNCTIONALITY ATTACHED TO VISUAL ASSETS IN COMPUTING SYSTEMS

(71) Applicant: FIGMA, INC., San Francisco, CA (US)

(72) Inventors: Alexander Simon KERN, San Mateo, CA (US); Benjamin DREBING, Brooklyn, NY (US); Nikolas KLEIN, San Francisco, CA (US)

(21) Appl. No.: 19/183,634

(22) Filed: Apr. 18, 2025

(51) Int. Cl. G06F 8/30

(52) U.S. Cl. CPC G06F 8/30

(57) ABSTRACT

Embodiments of the present disclosure provide techniques for generating functional visual assets in a design environment for execution in an execution environment. An example method includes receiving a request to attach functionality to a visual asset rendered on a canvas in a design environment, wherein the functionality is defined in a code asset usable across visual assets in the design environment. A deployable component is generated based on wrapping the code asset around rendering code associated with the visual asset, the wrapping attaching the functionality to the visual asset in an execution environment. The deployable component is deployed into the execution environment, and upon detecting an occurrence of a defined event with respect to the visual asset in the execution environment, the defined event being identified in the code asset, executing the attached functionality.

### BACKGROUND

### Field of the Various Embodiments

Embodiments of the present disclosure relate generally to graphic design tools and, more specifically, to techniques for generating and modifying visual content in a graphic design tool.

### Description of the Related Art

Graphic design tools generally allow for the creation of visual assets in a design environment. These visual assets may be defined, for example, as vector assets defined in terms of mathematical relationships between different components or raster assets defined in terms of absolute pixel locations. In some cases, a visual asset may include one or more containers, defined in the vector space, in which raster assets (e.g., images) can be inserted. A visual asset may include any number of visual components, and a visual asset may be defined in terms of relative positioning or other spatial relationships between visual components in the visual asset.

In many workflows, the process of designing a visual asset may be decoupled from the process of generating code used to implement the visual asset in an executable environment outside of the design environment. The code used to implement the visual asset in the executable environment may include code that defines the appearance of the visual asset and code that defines the functionality of the visual asset. The functionality of the visual asset can be defined in terms of triggers and actions, where a specific trigger (e.g., the occurrence of an event with respect to a visual asset) causes the execution of a specific action or set of actions. As the functionality of the visual asset becomes more complex, additional code may be used to implement complex tasks performed by the visual asset.

In a design environment, a visual asset and the code defining the functionality of a visual asset may be decoupled. That is, to implement functionality for a visual asset, code may be separately developed to implement the functionality. As the desired functionality of a visual asset becomes more complex, the associated code to implement the desired functionality for the visual asset may also increase in complexity and may involve repeated iterations of editing and deployment into a test environment for testing and debugging until the desired functionality is implemented.

As the foregoing illustrates, what is needed are more effective techniques for adding functionality to visual content in a design environment.

### SUMMARY

One embodiment of the present disclosure provides techniques for defining reusable functionality for visual assets in a design environment. An example method includes receiving a definition of a set of actions to be performed upon occurrence of defined events with respect to a visual asset on a canvas in a design environment. A reusable code asset decoupled from the visual asset implementing the set of actions is generated based on a mapping between states of the visual asset and actions in the set of actions. The reusable code asset is deployed to the design environment.

One embodiment of the present disclosure provides techniques for generating functional visual assets in a design environment for execution in an execution environment. An example method includes receiving a request to attach functionality to a visual asset rendered on a canvas in a design environment, wherein the functionality is defined in a code asset usable across visual assets in the design environment. A deployable component is generated based on wrapping the code asset around rendering code associated with the visual asset, the wrapping attaching the functionality to the visual asset in an execution environment. The deployable component is deployed into the execution environment. Upon detecting an occurrence of a defined event with respect to the visual asset in the execution environment, the defined event being identified in the code asset, executing the attached functionality.

One technical advantage of the disclosed techniques relative to the prior art is that the disclosed techniques allow for functionality for a visual asset to be defined in reusable external code assets that can be applied to visual assets in a design environment. The reusable external code asset may support functionality of varying complexity and allow for different actions to be performed based on different triggers and states of a visual asset. Further, by defining functionality for a visual asset in a reusable external code asset, embodiments presented herein may allow for working functionality to be attached to visual assets in a design environment without incurring the expense of compiling code and executing code in a test environment prior to deployment.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present disclosure.

FIG. 2 is a flow diagram of method steps for generating reusable external code assets implementing state-based functionality for a visual asset in a design environment, according to some embodiments.

FIG. 3 is a flow diagram of method steps for deploying functionality in reusable code assets to visual assets in a design environment for execution in an execution environment, according to some embodiments.

FIG. 4 illustrates a network computing system to implement an interactive graphic application platform, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

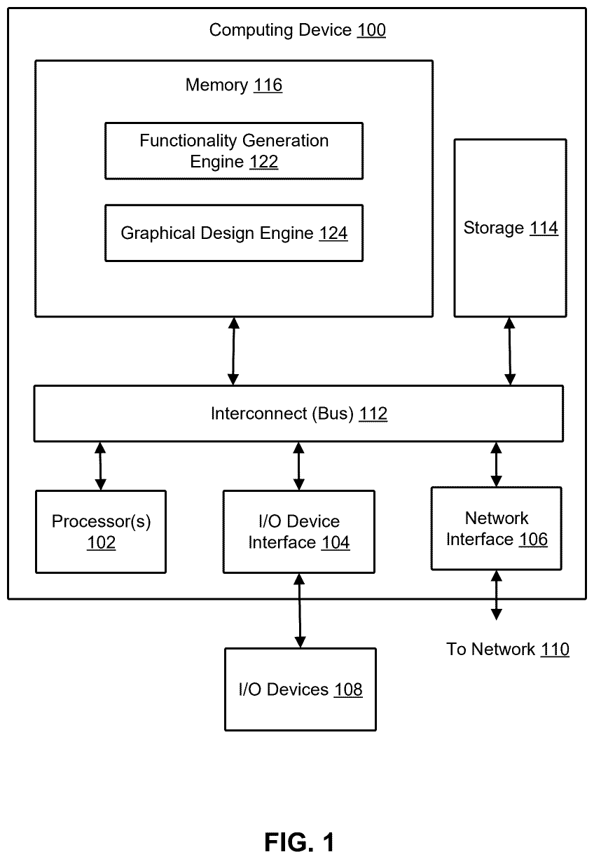

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a functionality generation engine 122 and a graphical design engine 124 that reside in a memory 116.

It is noted that the computing device described herein is illustrative and that any other technically feasible configurations fall within the scope of the present disclosure. For example, multiple instances of functionality generation engine 122 or graphical design engine 124 could execute on a set of nodes in a distributed and/or cloud computing system to implement the functionality of computing device 100. In another example, functionality generation engine 122 or graphical design engine 124 could execute on various sets of hardware, types of devices, or environments to adapt functionality generation engine 122 or graphical design engine 124 to different use cases or applications. In a third example, functionality generation engine 122 or graphical design engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Functionality generation engine 122 and graphical design engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including functionality generation engine 122 or graphical design engine 124.

### Example Reusable Functionality for Visual Assets in a Design Environment

In graphical design software, such as that implemented by the graphical design engine 124 illustrated in FIG. 1, visual assets, such as user interface components in a user interface under design in the graphical design engine 124, may be rendered and designed. A visual asset, as used herein, may be a group of visual components rendered in a user interface. Visual assets may be defined a priori (e.g., as code templates or pre-designed code-defined visual components in the graphical design engine 124) or may be designed by a user of the graphical design engine 124 and implemented in code. The visual asset may be, for example, a canvas in which other visual assets are rendered and in which user interaction can be processed, interactive visual assets rendered on a canvas, or the like.

Generally, the functionality of a visual asset may be defined in terms of triggers (also referred to as triggering events), actions, and states of the visual asset. For example, a specific action may be performed when a trigger occurs, and the specific action may depend on the current state of the visual asset. The current state of the visual asset may include, for example, content included in the visual asset (e.g., text, images, etc.), user interaction information associated with the visual asset at the current time (e.g., whether the visual asset has focus, is the subject of current interaction, has a pointer hovering over the visual asset, etc.), position information associated with the visual asset (e.g., X/Y coordinates on a grid, the direction in which the visual asset is pointing (if the visual asset is directional), or the like. Some actions may be performed once or may not be repeatable when the visual asset is in a given state. In an illustrative example, rendering undisplayed content (i.e., making content appear on screen) may only occur if the content is not visible when a triggering event (e.g., interaction with a button, scrolling to a defined location in a webpage or other document, etc.) occurs; if the content is already visible, the content may not appear again. In another example, different actions may occur for the same trigger depending on the state of the visual asset; for example, in a scrolling action defined for the visual asset, scrolling behavior such as the speed at which content appears or a style in which content appears (e.g., a transformation applied to previously-displayed content that results in the display of new content) may differ based on the location in the content that is being displayed or other state information associated with the visual asset in which the content is being displayed.

To allow for complex functionality to be created and reused across visual assets in a design environment, embodiments presented herein provide techniques for generating reusable code assets defining the functionality of a visual asset. The functionality of a visual asset may be defined as a composition of triggers and actions to allow for a variety of actions to be added to a visual asset in a design environment. Each action may be associated with a triggering event and a state of the visual asset. When deployed to an execution environment (e.g., as a website, an executable application package executing on a computing device, etc.), actions may be performed when a triggering event occurs based on the current state of the visual asset. By doing so, embodiments described herein may allow for reusability of functional code associated with visual assets and rapid development of functional user interfaces. Because functionality applied to a visual asset in a design environment may be defined as a composition of state-based triggers and associated actions, embodiments presented herein may accelerate the process of building working functional user interfaces and may minimize, or at least reduce, the amount of computing resources used in developing and debugging the functionality of visual assets in a design environment.

In some embodiments, to generate reusable code assets implementing functionality for a visual asset in a design environment, functionality generation engine 122 may receive an input specifying the functionality to be performed by a visual asset in the design environment. The input may be, for example, a natural language prompt specifying a set of actions to be performed by the visual asset, a list of pre-defined actions to be performed, or the like. In some embodiments, actions in the set of actions may be defined in a code editor in the design environment executed by graphical design engine 124.

Generally, the input specifying the functionality to be performed by the visual asset may include a specification of actions and triggers associated with the actions. A trigger may be an event performed in an execution environment in which the visual asset is deployed that causes an action to be performed. Events may include, for example, scrolling behavior (e.g., within a webpage or document that causes the portion of the webpage or document being displayed to change), hovering behavior (e.g., placing a mouse cursor over a visual asset or moving the mouse cursor from the visual asset), focus behavior, or the like. Generally, when an event occurs, a message indicating that the event has occurred may be generated and broadcast for ingestion by an event handler associated with the visual asset on which the event occurs.

To allow for complex functionality to be defined for a visual asset, functionality generation engine 122 uses the set of actions in the received input, triggering events associated with the actions, and state information associated with the triggering events and actions to generate a code asset associated with the visual asset. The code asset may, in some embodiments, include data structures specifying the state information and the triggering events. Functionality generation engine 122 can use the enumeration of the state information and the triggering events to generate event handlers that trigger the execution of specific actions based on different combinations of a state of the visual asset (and, in some embodiments, state information associated with related visual assets) and triggering events. These actions may be, for example, defined as code in the code asset that modify the behavior of the visual asset to which the code asset is attached or other visual assets rendered on a canvas in the design environment. In some embodiments, the code may be generated by a generative artificial intelligence model based on an input prompt defining the functionality to be performed with respect to one or more visual assets on the canvas when a specified triggering event occurs. As discussed, the defined functionality may be separated from the specified triggering event, with code invoking the defined functionality being included in an event handler associated with the visual asset and the defined functionality being included in a standalone function within the code asset.

In some embodiments, different actions may be defined based on the current and destination states of the visual asset. In such a case, triggering events may be defined directionally. That is, a triggering event that causes the state of a visual asset to change from a first state to a second state may be defined as a different triggering event from a triggering event that causes the state of the visual asset to change from the second state to the first state.

In some embodiments, functionality generation engine 122 can implement one or more event handlers based on the enumeration of states and triggering events. An event handler for a visual asset may be dedicated to a specific type of triggering event and may invoke specific functionality (e.g., an action from a set of actions defined for a visual asset) based on the current state of the visual asset. In some embodiments, a single event handler may be associated with a specific visual asset and may listen for and react to any of a variety of events performed with respect to that specific visual asset. In such a case, the event handler can invoke functionality (e.g., an action from a set of actions defined for a visual asset) based on the current state of the visual asset and the triggering event that was detected. In some embodiments, an event handler may be triggered by messages emitted within an execution environment in which the visual asset is deployed, with the messages specifying the triggering event and the visual asset in which the triggering event occurred.

In some embodiments, functionality generation engine 122 may allow actions to be performed any number of times based on the current state of the visual asset for which functionality is being created. For example, functionality generation engine 122 may include rules that allow for certain actions to be performed only when specific conditions are true. For an action that causes a visual asset to appear on a user interface, for example, functionality generation engine 122 may restrict execution of the action to situations in which the visual asset is not already rendered on the canvas. In another example, functionality generation engine 122 may apply different parameters for an action based on the current state of the visual asset. For a scrolling action, for example, the scroll speed may accelerate and decelerate based on the current position of the visual asset.

As an illustrative example, suppose that functionality generation engine 122 is prompted to generate functionality for a directional controller (e.g., a D-pad) used to control another visual asset rendered on a canvas. A set of triggering events for the directional controller may be defined as an interaction (e.g., clicking, tapping on a touchscreen, etc.) with a specific portion of the directional controller (e.g., the up portion, down portion, right portion, or left portion). A set of actions to be performed may be defined with respect to the current state of the visual asset being controlled by the directional controller. For example, a current state of the visual asset being controlled by the directional controller may be defined in terms of whether the visual asset is at a boundary that blocks movement of the visual asset (e.g., whether the visual asset is at one or more of a top boundary, a bottom boundary, a left boundary, or a right boundary).

To implement the desired functionality, functionality generation engine 122 can generate a code asset including code that causes the visual asset being controlled by the directional controller to move based on the state of the visual asset. For example, when a triggering event is detected, the visual asset can be moved in a direction corresponding to the portion of the directional controller on which the triggering event is detected.

Functionality generation engine 122 can further generate, in the event handler for the directional controller, actions corresponding to a state of the visual asset at a boundary based on whether wraparound functionality is to be implemented (e.g., whether, if at a border of a defined area, the visual asset is moved to an opposite border of the visual asset, such as going from the rightmost position of a container to the leftmost position of the container when the visual asset is moved rightward). If wraparound functionality is specified within the definition of the functionality for the directional controller, functionality generation engine 122 can generate an action that causes the visual asset controlled by the directional controller to wraparound (e.g., to move from the top of a defined area to the bottom of the defined area). If, however, wraparound functionality is disallowed according to the definition of the functionality for the directional controller, functionality generation engine 122 can perform a no-op when a triggering event is detected and the visual asset is located at a boundary or can perform an action other than moving the visual asset.

In some embodiments, the functionality generated by functionality generation engine 122 for a visual asset may be transformed into a reusable code asset that can be used in other design environments or by other visual assets within a same design environment. To allow for the functionality defined for a visual asset to be reused, functionality generation engine 122 can generate the code asset as a standalone code asset that can be duplicated and attached to other visual assets within a design environment. In generating the standalone code asset, functionality generation engine 122 can, in some embodiments, replace references to specific visual assets in the code asset to a generic placeholder. The generic placeholder may be replaced with references to specific visual assets when the code asset is attached to a visual asset in a design environment.

In some embodiments, a visual asset and the functionality associated with the visual asset may be coupled and included in a layer on a canvas in a design environment. The layer in the design environment generally serves as a container in which modifications to the visual asset and/or the functionality associated therewith are contained; modifications to a visual asset and/or the functionality therewith may be restricted to the layer and may not be propagated to instances of the visual asset in other layers on a canvas in the design environment. To allow for iterative development of the visual asset and the functionality associated with the visual asset, layers may be duplicated on the canvas. In duplicating a layer, the code assets associated with the appearance of the visual asset and the functionality of the visual asset may be duplicated, and the code asset defining the functionality of the visual asset may be attached to the visual asset within the new layer.

Graphical design engine 124 generally allows for functionality defined in a reusable code asset (e.g., by functionality generation engine 122) to be attached to a visual asset rendered on a canvas in a design environment and for the combination of the code asset and visual asset to be deployed to an execution environment. Generally, graphical design engine 124 can present, to a user of the design environment, an enumeration of functionality presets that can be attached to a visual asset to add functionality to the visual asset. Each functionality preset enumerated by the graphical design engine 124 may be associated with a corresponding code asset that graphical design engine 124 can import and attach to a visual asset. As discussed, a code asset defining functionality to attach to a visual asset may define a composition of state-based triggers and actions performed when a triggering event occurs with the visual asset being in a specific state.

In some embodiments, a visual asset on a canvas in a design environment may be defined as rendering code that, when executed, causes the visual asset to be rendered on a screen or other display device. To attach functionality defined in a code asset to a visual asset on a canvas, graphical design engine 124 can generate a deployable component based on wrapping the code asset around the rendering code associated with the visual asset. To wrap the rendering code, graphical design engine 124 can generate a first container including the code asset associated with the functionality to be attached to the visual asset. Within the first container, graphical design engine 124 can generate a second container that includes the rendering code for the visual asset.

In some embodiments, various design variables defined within the design environment can be used for parameterization of various functionality defined in a code asset attached to a visual asset in the design environment. These design variables may be, for example, settings that define various properties of a visual asset, such as a text color (or set of text colors), animation speed, or the like. When a functionality preset is attached to a visual asset, the design variables can be used by the code asset implemented by the functionality preset to control the appearance and/or behavior of the visual asset.

In some embodiments, a functionality preset may include various parameters that can control the behavior of the functionality preset. For example, these parameters may control the appearance of the visual asset to which the functionality preset is attached, how content included in the visual asset is rendered, and the like. Generally, the parameters in the functionality preset may take on values from design variables defined within the design environment such that the functionality preset functions without deviating from the properties based on which designs in the design environment are rendered.

After generating a deployable component that includes a visual asset and the code associated with the functionality to be implemented by the visual asset, graphical design engine 124 deploys the deployable component to an execution environment. During execution, an event handler associated with the deployable component listens for the occurrence of defined triggering events with respect to the visual asset. When a defined triggering event occurs, a message is emitted indicating the visual asset for which the triggering event has occurred and the type of the triggering event. Based on the occurrence of the triggering event and the current state of the visual asset, the event handler associated with the visual asset, upon ingesting the emitted message, performs a specified action with respect to the visual asset or another visual asset in the execution environment.

In some embodiments, graphical design engine 124 can deploy the deployable component in the execution environment by rendering the visual asset encapsulated in the deployable component. In rendering the visual asset, components may be included in a rendering path represented by a tree data structure. The tree data structure generally specifies visual components rendered on a screen as a set of dependencies represented by parent-child relationships in the tree. A first visual asset serving as a container in which a second visual asset is contained may be defined as a parent node in the tree data structure to a node associated with the second visual asset. Further, the functionality attached to the visual asset may be represented by one or more nodes in the tree data structure. In some embodiments, the functionality attached to the visual asset may be a parent node of the highest-level node associated with the visual asset to which the functionality is attached. For example, for functionality that adjusts the speed at which content is displayed on a canvas when scrolling, the functionality may be a parent node of the node representing the canvas.

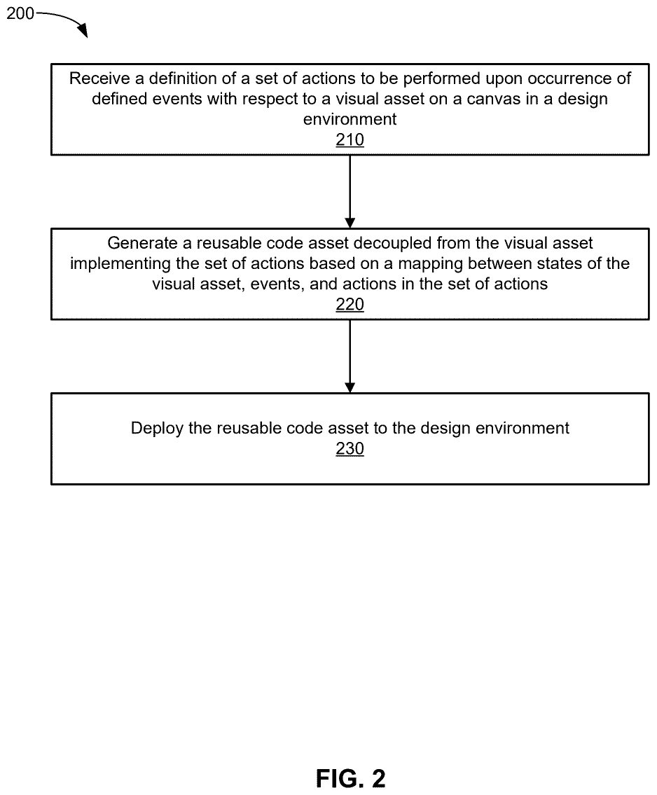

FIG. 2 is a flow diagram illustrating example operations 200 for generating reusable code assets implementing state-based functionality for a visual asset in a design environment, according to some embodiments. The operations 200 may be performed, for example, by a computing system including one or more processors, such as the processor(s) 102 of the computing device 100 illustrated in FIG. 1, on which a functionality generation engine 122 executes.

As illustrated, the operations 200 begin at block 210, where the functionality generation engine 122 receives a definition of a set of actions to be performed upon occurrence of defined events with respect to a visual asset on a canvas in a design environment. The visual asset may be, for example, the canvas in the design environment or a set of visual components included on the canvas.

In some embodiments, the definition of the set of actions may include a set of state-based triggers and a corresponding action for each trigger in the set of state-based triggers. A state-based trigger may, in some embodiments, be defined by an event triggered by user activity within a user interface with respect to a visual asset (e.g., an action performed on hover, on exit, when a scroll event occurs, on click, on gaining or losing focus, etc.), and at least a current state of the visual asset. Generally, a state-based trigger that causes the state of the visual asset to transform from a first state to a second state may be different from a state-based trigger that causes the state of the visual asset to transform from the second state to the first state and may trigger the execution of different actions.

In some embodiments, the set of actions may be selected from a predefined set of actions. An action may generally define a plurality of behaviors, with each behavior being associated with a state of the visual asset.

In some embodiments, the set of actions may include code defining an action performed with respect to the visual asset upon occurrence of a defined event when the visual asset is in a defined state. The code may be, for example, generated by a generative artificial intelligence model deployed as part of functionality generation engine 122 that generates code to implement functionality defined in an input prompt (e.g., a natural language prompt describing the functionality, an image-based prompt illustrating a change to a visual asset that occurs when a defined triggering event occurs, or other prompt in one or more modalities based on which code implementing functionality for a visual asset can be generated). In some embodiments, the code may be written in a control panel presented in a design environment.

At block 220, operations 200 proceed with the functionality generation engine 122 generating a reusable code asset implementing the set of actions based on a mapping between states of the visual asset, events, and actions in the set of actions. Generally, the reusable code asset may be decoupled from the visual asset such that code defining the appearance of the visual asset is a separate asset from the reusable code asset implementing the set of actions.

In some embodiments the functionality generation engine 122 can generate the reusable code asset from a code asset attached to the visual asset in the design environment. In some embodiments, a visual asset in the design environment may be contained in a layer on a canvas in the design environment. The layer may represent a container in which the visual asset and a code asset implementing functionality for the visual asset are contained. Edits to a visual asset or the functional code associated therewith within a layer may be isolated to that layer; that is, edits to an instance of a visual asset in a layer may not be propagated to instances of the visual asset in other layers on the canvas. To allow for the external code asset to be reused, the code asset associated with a visual asset may be detached from the visual asset and saved in a code repository in which code associated with predefined, reusable functionality is stored.

In some embodiments, a visual asset and code asset implementing functionality for the visual asset may be duplicated within the design environment to allow for iteration of the visual asset and/or the functionality attached to the visual asset. To duplicate a visual asset and the code asset implementing functionality for the visual asset, a new instance of the visual asset and the code asset may be copied from an extant instance of the visual asset and the code asset. In embodiments in which the visual asset and code asset are duplicated in a new layer on the canvas in the design environment, the copy of the visual asset and the copy of the code asset may be included in the new layer. In embodiments in which the visual asset and the code asset are duplicated in a same layer on the canvas, the copy of the visual asset may reference the extant copy of the code asset in the layer.

At block 230, operations 200 proceed with the functionality generation engine 122 deploying the reusable code asset to the design environment. In deploying the reusable code asset to the design environment, functionality generation engine 122 can implement the functionality defined in the reusable code asset when the reusable code asset is attached to other visual assets created in the design environment.

In some embodiments, reusable code assets generated in a design environment 200 can be packaged into a shareable library of reusable code assets. To use a library of reusable code assets in a design environment 200, a shared library may be imported into the design environment 200. Predefined interactions associated with the assets in the library of reusable assets may be selectable within design environment 200 and attached to various visual assets rendered on a canvas in the design environment. By doing so, embodiments of the present disclosure may allow for interactions defined for a design rendered in one design environment to be exported and implemented in designs rendered in other design environments.

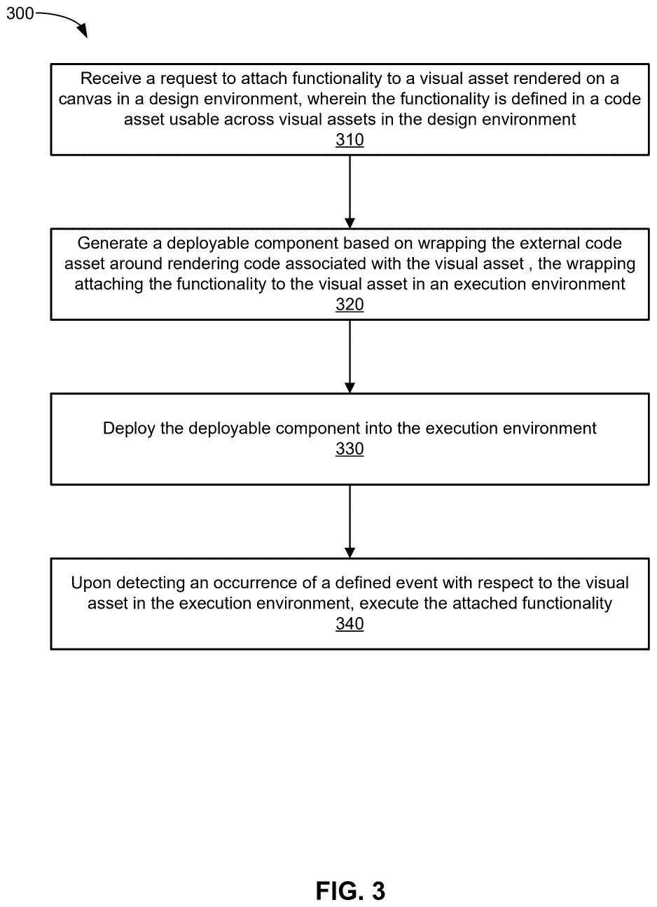

FIG. 3 is a flow diagram illustrating example operations 300 for deploying functionality in reusable code assets to visual assets in a design environment for execution in an execution environment, according to some embodiments. The operations 300 may be performed, for example, by a computing system including one or more processors, such as the processor(s) 102 of the computing device 100 illustrated in FIG. 1, on which a graphical design engine 124 executes.

As illustrated, the operations 300 begin at block 310, where the graphical design engine 124 receives a request to attach functionality to a visual asset rendered on a canvas in a design environment. Generally, the functionality may be defined in a code asset usable across visual assets in the design environment.

In some embodiments, the functionality is defined as a composition of triggers and actions, each respective trigger being associated with a respective action. The triggers may be, for example, state-based triggers in which the combination of a triggering event and the current state of a visual asset is associated with a specific action from the set of actions. As discussed, actions defined for a triggering event and state of the visual asset generally involve actions that cause the state of the visual asset to change from a first state to a second state. A triggering event that causes the state of the visual asset to change from the first state to the second state may execute a different action in the set of actions from a triggering event that causes the state of the visual asset to change from the second state to the first state.

At block 320, the graphical design engine 124 generates a deployable component based on wrapping the code asset around rendering code associated with the visual asset. Generally, the wrapping attaches the functionality to the visual asset in an execution environment.

In some embodiments, wrapping the rendering code associated with the visual asset may include the graphical design engine 124 generating a first container including the code asset associated with the functionality. The graphical design engine 124 then generates a second container including rendering code for the visual asset, the second container being contained within the first container.

At block 330, the graphical design engine 124 deploys the deployable component into the execution environment.

At block 340, upon detecting an occurrence of a defined event with respect to the visual asset in the execution environment, the defined event being identified in the code asset, the graphical design engine 124 executes the attached functionality.

In some embodiments, operations 300 further include the graphical design engine 124 receiving an input defining the functionality in a code editor in the design environment.

In some embodiments, the request to attach the functionality to the visual asset comprises a request to preview the functionality defined by the input in the code editor in a sandbox in the code environment.

In some embodiments, operations 300 further include the graphical design engine 124 receiving an input defining the functionality as a set of actions performed based on different states of the visual asset.

In some embodiments, graphical design engine 124 deploys the deployable component into the execution component by rendering the visual asset in the execution environment based on a tree-defined rendering path in which the functionality is represented by a node in the tree and the visual asset is defined as one or more child nodes of the node representing the functionality.

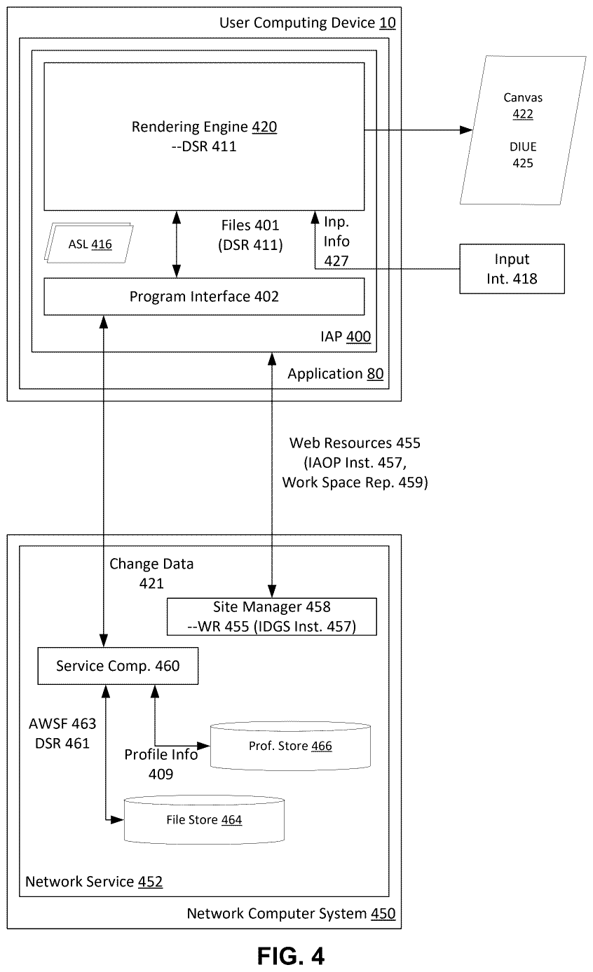

FIG. 4 illustrates a network computing system to implement an interactive application platform on a user computing device, according to some embodiments. A network computing system such as illustrated in FIG. 4 can be implemented using one or more servers which communicate with user computing devices over one or more networks. The network computer system 450 illustrated in FIG. 4 may correspond, for example, to the computing device 100 illustrated in FIG. 1 and can be used to generate and/or modify visual content based on generative artificial intelligence models and an input prompt specifying a design objective for the visual content.

In some embodiments, the network computing system 450 performs operations to enable an interactive application platform (“IAP 400”) to be implemented on user computing devices 10. In some embodiments, the IAP 400 can be implemented by the user initiating a session (e.g., user accessing a website) to receive programmatic resources of the IAP 400. A browser component executes the programmatic resources to implement the IAP 400, with functionality to receive user input and to render content that is based on or responsive to user input. As described, the IAP 400 is implemented to enable the user to create various types of content, such as interactive graphic designs, art, whiteboard content, program code renderings, presentations, and/or textual content. As further described, the IAP 400 can include logic (“ASL 416”) for implementing one or more application services, where each application service is implemented through the IAP 400 to provide a corresponding set of functionality and user experience. The IAP 400 also implements the application services to share some resources, such as the canvas, workspace file or library of design elements. Further, the IAP 400 enables multiple application services to be used during a given online session and/or with respect to a particular application service.

According to some embodiments, a user of computing device 10 operates web-based application 80 to access a network site, where programmatic resources are retrieved and executed to implement the IAP 400. The web-based application 80 can execute scripts, code and/or other logic (the “programmatic components”) to implement functionality of the IAP 400. In some embodiments, the web-based application 80 can correspond to a commercially available browser, such as GOOGLE CHROME (developed by GOOGLE, INC.) or SAFARI (developed by APPLE, INC.). In some embodiments, the processes of the IAP 400 can be implemented as scripts and/or other embedded code which web-based application 80 downloads from a network site. For example, the web-based application 80 can execute code that is embedded within a webpage to implement processes of the IAP 400. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some embodiments, the rendering engine 420 may utilize graphics processing unit (GPU) accelerated logic, such as provided through WebGL (Web Graphics Library) programs which execute Graphics Library Shader Language (GLSL) programs that execute on GPUs.

The IAP 400 can be implemented as part of a network service, where web-based application 80 communicates with one or more remote computers (e.g., server used for a network service) to execute processes of the IAP 400. The web-based application 80 retrieves some or all of the programmatic resources for implementing the IAP 400 from a network site. The web-based application 80 may also access various types of data sets in providing the IAP 400. The data sets can correspond to files and design libraries (e.g., predesigned design elements), which can be stored remotely (e.g., on a server, in association with an account) or locally. In some embodiments, the network computer system 450 provides a shared design library which the user computing device 10 can use with any of the application services provided through the IAP 400. In this way, the user may initiate a session to implement the IAP 400 for the purpose of creating or editing the workspace file, as rendered on the canvas 422, in accordance with one of multiple collaborative application services of the IAP 400.

In some embodiments, the IAP 400 includes a program interface 402, an input interface 418 and a rendering engine 420. The program interface 42 can include one or more processes which execute to access and retrieve programmatic resources from local and/or remote sources. In an implementation, the program interface 402 can generate, for example, a canvas 422, using programmatic resources which are associated with web-based application 80 (e.g., HTML 5.0 canvas). As an addition or variation, the program interface 402 can trigger or otherwise cause the canvas 422 to be generated using programmatic resources and data sets (e.g., canvas parameters) which are retrieved from local (e.g., memory) or remote sources (e.g., from network service).

The program interface 402 may also retrieve programmatic resources that include an application framework for use with canvas 422. The application framework can include data sets which define or configure, for example, a set of interactive graphic tools that integrate with the canvas 422 and which comprise the input interface 418, to enable the user to provide input to generate or update content rendered on the canvas 422.

According to some embodiments, the input interface 418 can be implemented as a functional layer that is integrated with the canvas 422 to detect and interpret user input. The input interface 418 can, for example, process a user's interaction with an input mechanism (e.g., pointer device, keyboard) of the user computing device, to detect, for example, cursor positioning/movement with respect to the canvas 422, hover input (e.g., pre-selection input), selection input (e.g., clicks or double clicks), shortcuts (e.g., key board inputs) and other inputs. In processing a user's interaction with a pointer device, the input interface 418 can use a reference of the canvas 422 to identify a screen location of a user's cursor as the user moves or otherwise interacts with the pointer device. Additionally, the input interface 418 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In some embodiments, the input interface 418 can interpret, for example, a series of inputs as a design tool selection (e.g., shape selection based on location of input), as well as inputs to define attributes (e.g., dimensions) of a selected shape. In some embodiments, the input interface 418 can interpret a continuous input (corresponding to a continuous movement of the user's pointer device) as selecting a tool (e.g., shape too) and canvas location where an output of the selected tool is to appear.

In some embodiments, the IAP 400 includes application service logic 416 to enable multiple application services to be utilized during a given user session, where each application service provides the user with a particular functionality and/or user experience. As described by some embodiments, each application service is implemented by the IAP 400 utilizing a corresponding application service logic 416 to configure the interface component 418, rendering engine 420 and/or other components of the IAP 400 to provide the functionality and user experience of the corresponding application service. In this way, the IAP 400 enables the user to operate multiple application services during one online session. Further, the different application services can share resources, including programmatic resources of the IAP 400, such as canvas 422. In this way, each application service can contribute content to and/or utilize features and content provided with the canvas 422 during a given session. Still further, the application services can be implemented as alternative modalities of IAP 400, such that the user can toggle between modes, where each mode provides a particular functionality and user experience. In some embodiments, each application service can utilize a common workspace file associated with the user. By default, a computing device that opens the workspace file can utilize a default application service to access and/or update that workspace file. The user may also switch the mode of operation of the IAP 400 to utilize a different application service to access, use and/or update the workspace file.

The network computing system 450 can include a site manager 458 to manage a website where a set of web-resources 455 (e.g., web page) are made available for the web-based application 80 of user computing devices 10. The web-resources 455 can include instructions, such as scripts or other logic (“ICAP instructions 457”), which are executable by browsers or web components of user computing devices. The web resources 455 can also include (i) resources that are to be shared as between application services, provided to the user computing devices in connection with the user computing devices utilizing either of the application services, and (ii) application specific resources, which execute on the user computing devices for a particular one of the available application services. The web resources 455 can also include a design library of design elements that is partially or fully shared as between the application services. The library of design elements can enable the user to select predetermined design elements for use on the canvas 422 in connection with the user utilizing either of the application services.

In some variations, once the computing device 10 accesses and downloads the web-resources 455, web-based application 80 executes the IAP instructions 457 to implement functionality as described above. For example, the IAP instructions 457 can be executed by web-based application 80 to initiate the program interface 402 on the user computing device 10. The initiation of the program interface 402 may coincide with the establishment of, for example, a web-socket connection between the program interface 402 and a service component 460 of the network computing system 450.

In some embodiments, the web-resources 455 includes logic which web-based application 80 executes to initiate one or more processes of a program interface 402, causing the IAP 400 to retrieve additional programmatic resources and data sets for implementing functionality as described by examples. The web resources 455 can, for example, embed logic (e.g., JAVASCRIPT code), including GPU accelerated logic, in an HTML page for download by computing devices of users. The program interface 402 can be triggered to retrieve additional programmatic resources and data sets from, for example, the network service 452, and/or from local resources of the computing device 10, in order to implement each of the multiple application services of the IAP 400. For example, some of the components of the IAP 400 can be implemented through webpages that can be downloaded onto the computing device 10 after authentication is performed, and/or once the user performs additional actions (e.g., download one or more pages of the workspace associated with the account identifier). Accordingly, in examples as described, the network computing system 450 can communicate the IAP instructions 457 to the computing device 10 through a combination of network communications, including through downloading activity of web-based application 80, where the IAP instructions 457 are received and executed by web-based application 80.

The computing device 10 can use web-based application 80 to access a website of the network service 452 to download the webpage or web resource. Upon accessing the website, web-based application 80 can automatically (e.g., through saved credentials) or through manual input, communicate an account identifier to the service component 460. In some embodiments, web-based application 80 can also communicate one or more additional identifiers that correlate to a user identifier.

Additionally, in some embodiments, the service component 460 can use the user or account identifier of the user identifier to retrieve profile information 409 from a user profile store 466. As an addition or variation, profile information 409 for the user can be determined and stored locally on the user's computing device 10.

The service component 460 can also retrieve the files of an active workspace (“active workspace files 463”) that are linked to the user account or identifier from a file store 464. The profile store 466 can also identify the workspace that is identified with the account and/or user, and the file store 464 can store the data sets that comprise the workspace. The data sets stored with the file store 464 can include, for example, the pages of a workspace and one or more data structure representations 461 for the design under edit which is renderable from the respective active workspace files.

As an addition or variation, each file can be associated with metadata that identifies the application service that was used to create the particular file. In some embodiments, the metadata identifies the default application service for viewing, utilizing or otherwise updating the application service.

Additionally, in some embodiments, the service component 460 provides a representation 459 of the workspace associated with the user to the web-based application 80, where the representation identifies, for example, individual files associated with the user and/or user account. The workspace representation 459 can also identify a set of files, where each file includes one or multiple pages, and each page including objects that are part of a design interface.

On the user device 10, the user can view the workspace representation through web-based application 80, and the user can elect to open a file of the workspace through web-based application 80. In some embodiments, upon the user electing to open one of the active workspace files 463, web-based application 80 initiates the canvas 422. For example, the IAP 40 can initiate an HTML 5.0 canvas as a component of web-based application 80, and the rendering engine 120 can access one or more data structures representations 411 of content rendered on the canvas 422.

The IAP 400 utilizes application service logic 416 to implement multiple modes of operation, where each mode corresponds to an application service. As described, the application service logic 416 associated with each service application can include instructions and data for configuring the components of IAP 400 to include functionality and features of the corresponding application service. Accordingly, the application service logic 416 can, for example, configure the application framework and/or input interface 418 to differ in form, functionality and/or configuration as between the alternative modes of the IAP 400. Additionally, the type of actions and interactions which the user can perform to register input can vary based on the modes of operation. Still further, the different modes of operation can include different input or user-interface features for the user to select and use for inclusion on the canvas 422. By way of example, when the IAP 400 is operating in a mode for whiteboarding service application, the program interface 402 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 422.

Additionally, the application service logic 416 can configure the operation of the rendering engine 420, such that the functionality and behavior of the rendering engine 420 differs as between different application services. In this way, the rendering engine 420 functions to provide alternative behaviors for different modes of operation, coinciding with the particular service application that is active. By way of example, the configuration of the rendering engine 420 can affect the appearance of the canvas 422, the appearance (e.g., visual attributes) of rendered content elements on the canvas 422, the behavior or representation of user interaction (e.g., whether the user cursor or pointe device is represented on the canvas 422), the type or specific content that is rendered, the physic engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In some embodiments, each application service enables the user to update the workspace file even while the workspace file is in use by other computing devices (e.g., such as in a collaborative environment). In some embodiments, the user can mode switch the IAP 400 to switch which application service is in use, with each application service utilizing the workspace file.

### EXAMPLE CLAUSES

Various aspects of the present disclosure are described in the following numbered clauses.

1. In some embodiments, a processor-implemented method, comprising: receiving a definition of a set of actions to be performed upon occurrence of defined events with respect to a visual asset on a canvas in a design environment; generating a reusable code asset decoupled from the visual asset, the reusable code asset implementing the set of actions based on a mapping between states of the visual asset and actions in the set of actions; and deploying the reusable code asset to the design environment.

2. The method of clause 1, wherein the definition of the set of actions comprises a set of state-based triggers and a corresponding action for each trigger in the set of state-based triggers.

3. The method of any of clauses 1 or 2, wherein a first action in the set of actions causes a state of the visual asset to transition from a first state to a second state, and wherein a second action different from the first action causes a state of the visual asset from the second state to the first state.

4. The method of any of clauses 1 through 3, wherein generating the reusable code asset comprises generating the reusable code asset from a code asset attached to the visual asset in the design environment.

5. The method of clause 4, further comprising: duplicating the visual asset on the canvas in the design environment; and duplicating the code asset attached to the visual asset, wherein the duplicated code asset is attached to the duplicated visual asset.

6. The method of any of clauses 4 or 5, wherein the set of actions are selected from a predefined set of actions.

7. The method of clause 6, wherein an action in the set of actions defines a plurality of behaviors, each respective behavior of the plurality of actions being associated with a respective state in a set of states for the visual asset.

8. The method of any of clauses 1 through 7, wherein the set of actions comprise code defining an action performed with respect to the visual asset upon occurrence of a defined event when the visual asset is in a defined state.

9. The method of any of clauses 1 through 8, wherein the visual asset comprises the canvas in the design environment.

10. In some embodiments, a processor-implemented method, comprising: receiving a request to attach functionality to a visual asset rendered on a canvas in a design environment, wherein the functionality is defined in a code asset usable across visual assets in the design environment; generating a deployable component based on wrapping the code asset around rendering code associated with the visual asset, the wrapping attaching the functionality to the visual asset in an execution environment; deploying the deployable component into the execution environment; and upon detecting an occurrence of a defined event with respect to the visual asset in the execution environment, the defined event being identified in the code asset, executing the attached functionality.

11. The method of clause 10, wherein the functionality is defined as a composition of triggers and actions, each respective trigger being associated with a respective action.

12. The method of any of clauses 10 or 11, wherein the functionality is defined as actions performed with respect to content in the visual asset based on a current state of the visual asset.

13. The method of any of clauses 10 through 12, wherein wrapping the rendering code associated with the visual asset comprises: generating a first container including the code asset associated with the functionality; and generating a second container including rendering code for the visual asset, the second container being contained within the first container.

14. The method of any of clauses 10 through 13, further comprising receiving an input defining the functionality in a code editor in the design environment.

15.The method of clause 14, wherein the request to attach the functionality to the visual asset comprises a request to preview the functionality defined by the input in the code editor in a sandbox in the code environment.

16. The method of any of clauses 10 through 15, further comprising receiving an input defining the functionality as a set of actions performed based on different states of the visual asset.

17. The method of any of clauses 10 through 16, wherein deploying the deployable component into the execution component comprises rendering the visual asset in the execution environment based on a tree-defined rendering path in which the functionality is represented by a node in the tree and the visual asset is defined as one or more child nodes of the node representing the functionality.

18. In some embodiments, a processor-implemented method, comprising: receiving a request to attach functionality to a visual asset rendered on a canvas in a design environment, wherein the functionality is defined in a code asset usable across visual assets in the design environment; generating a deployable component based on wrapping rendering code associated with the visual asset around the code asset, the wrapping attaching the functionality to the visual asset in an execution environment; deploying the deployable component into the execution environment; and upon detecting an occurrence of a defined event with respect to the visual asset in the execution environment, executing the attached functionality, wherein the defined event is identified in the code asset.

19. The method of clause 18, wherein the functionality is defined as a composition of triggers and actions, each respective trigger being associated with a respective action.

20. The method of any of clauses 18 or 19, wherein the functionality is defined as actions performed with respect to content in the visual asset based on a current state of the visual asset.

21. The method of any of clauses 18 through 20, wherein wrapping the rendering code associated with the visual asset comprises: generating a first container including the code asset associated with the functionality; and generating a second container including rendering code for the visual asset, the second container being contained within the first container.

22. The method of any of clauses 18 through 21, further comprising receiving an input defining the functionality in a code editor in the design environment.

23. The method of clause 22, wherein the request to attach the functionality to the visual asset comprises a request to preview the functionality defined by the input in the code editor in a sandbox in the code environment.

24. The method of any of clauses 18 through 23, further comprising receiving an input defining the functionality as a set of actions performed based on different states of the visual asset.

25. The method of any of clauses 18 through 24, wherein deploying the deployable component into the execution environment comprises rendering the visual asset in the execution environment based on a tree-defined rendering path in which the functionality is represented by a node in the tree and the visual asset is defined as one or more child nodes of the node representing the functionality.

26. A processing system, comprising: at least one memory having executable instructions thereon; and one or more processors configured to execute the executable instructions to cause the processing system to perform the method of any of clauses 1 through 25.

27. A processing system, comprising: means for performing the method of any of clauses 1 through 25.

28. A non-transitory computer-readable medium having executable instructions stored thereon which, when processed by one or more processors, causes the one or more processors to perform the method of any of clauses 1 through 25.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving a request to attach functionality to a visual asset rendered on a canvas in a design environment, wherein the functionality is defined in a code asset usable across visual assets in the design environment;
generating a deployable component based on wrapping rendering code associated with the visual asset around the code asset, the wrapping attaching the functionality to the visual asset in an execution environment;
deploying the deployable component into the execution environment; and
upon detecting an occurrence of a defined event with respect to the visual asset in the execution environment, executing the attached functionality, wherein the defined event is identified in the code asset.

2. The method of claim 1, wherein the functionality is defined as a composition of triggers and actions, each respective trigger being associated with a respective action.

3. The method of claim 1, wherein the functionality is defined as actions performed with respect to content in the visual asset based on a current state of the visual asset.

4. The method of claim 1, wherein wrapping the rendering code associated with the visual asset comprises:
generating a first container including the code asset associated with the functionality; and
generating a second container including rendering code for the visual asset, the second container being contained within the first container.

5. The method of claim 1, further comprising receiving an input defining the functionality in a code editor in the design environment.

6. The method of claim 5, wherein the request to attach the functionality to the visual asset comprises a request to preview the functionality defined by the input in the code editor in a sandbox in the code environment.

7. The method of claim 1, further comprising receiving an input defining the functionality as a set of actions performed based on different states of the visual asset.

8. The method of claim 1, wherein deploying the deployable component into the execution environment comprises rendering the visual asset in the execution environment based on a tree-defined rendering path in which the functionality is represented by a node in the tree and the visual asset is defined as one or more child nodes of the node representing the functionality.

9. A processing system, comprising:
at least one memory having executable instructions stored thereon; and
one or more processors configured to execute the executable instructions to cause the processing system to:
receive a request to attach functionality to a visual asset rendered on a canvas in a design environment, wherein the functionality is defined in a code asset usable across visual assets in the design environment;
generate a deployable component based on wrapping rendering code associated with the visual asset around the code asset, the wrapping attaching the functionality to the visual asset in an execution environment;
deploy the deployable component into the execution environment; and
upon detecting an occurrence of a defined event with respect to the visual asset in the execution environment, execute the attached functionality, wherein the defined event is identified in the code asset.

10. The processing system of claim 9, wherein the functionality is defined as a composition of triggers and actions, each respective trigger being associated with a respective action.

11. The processing system of claim 9, wherein the functionality is defined as actions performed with respect to content in the visual asset based on a current state of the visual asset.

12. The processing system of claim 9, wherein to wrap the rendering code associated with the visual asset, the one or more processors are configured to cause the processing system to:
generate a first container including the code asset associated with the functionality; and
generate a second container including rendering code for the visual asset, the second container being contained within the first container.

13. The processing system of claim 9, wherein the one or more processors are further configured to cause the processing system to receive an input defining the functionality in a code editor in the design environment.

14. The processing system of claim 13, wherein the request to attach the functionality to the visual asset comprises a request to preview the functionality defined by the input in the code editor in a sandbox in the code environment.

15. The processing system of claim 9, wherein the one or more processors are further configured to cause the processing system to receive an input defining the functionality as a set of actions performed based on different states of the visual asset.

16. The processing system of claim 9, wherein to deploy the deployable component into the execution environment, the one or more processors are configured to cause the processing system to render the visual asset in the execution environment based on a tree-defined rendering path in which the functionality is represented by a node in the tree and the visual asset is defined as one or more child nodes of the node representing the functionality.

17. A non-transitory computer-readable medium having executable instructions stored thereon which, when executed by one or more processors, performs an operation comprising:
receiving a request to attach functionality to a visual asset rendered on a canvas in a design environment, wherein the functionality is defined in a code asset usable across visual assets in the design environment;
generating a deployable component based on wrapping rendering code associated with the visual asset around the code asset, the wrapping attaching the functionality to the visual asset in an execution environment;
deploying the deployable component into the execution environment; and
upon detecting an occurrence of a defined event with respect to the visual asset in the execution environment, executing the attached functionality, wherein the defined event is identified in the code asset.

18. The non-transitory computer-readable medium of claim 17, wherein wrapping the rendering code associated with the visual asset comprises:
generating a first container including the code asset associated with the functionality; and
generating a second container including rendering code for the visual asset, the second container being contained within the first container.

19. The non-transitory computer-readable medium of claim 17, wherein the operations further comprise receiving an input defining the functionality in a code editor in the design environment.

20. The non-transitory computer-readable medium of claim 17, wherein the operations further comprise receiving an input defining the functionality as a set of actions performed based on different states of the visual asset.
